(19) United States
(12) Patent Application Publication
(10) Pub. No.: US 2025/0377690 A1
(43) Pub. Date: Dec. 11, 2025

(54) SMART WEARABLE ELECTRIC DEVICES AND METHODS FOR COMMUNICATION

(71) Applicant: Zumedia Inc., New York, NY (US)

(72) Inventor: Phyllis Jager, New York, NY (US)

(21) Appl. No.: 19/312,195

(22) Filed: Aug. 27, 2025

Related U.S. Application Data
(63) Continuation-in-part of application No. 18/387,441, filed on Nov. 6, 2023.
Application No. 18/387,441 is a continuation of application No. 17/333,064, filed on May 28, 2021, now abandoned.

(51) Int. Cl. G06F 1/16; G10L 13/02; G10L 15/18; G10L 15/22

(52) U.S. Cl. CPC G06F 1/163; G10L 13/02; G10L 15/18; G10L 15/22; G10L 2015/221; G10L 2015/223

(57) ABSTRACT

The present disclosure relates to wireless smart-phone and communication device that can be controlled through voice commands and embedded with software for a number of functionalities. The smart-phone device can comprise biometric and environmental sensors to enable the device to collect information regarding the user and the surrounding environment, infer a user's emotional state, and respond with adaptive actions. The smart-phone device can respond to voice commands, access databases through internet connectivity, and create a novel communication stream that informs both the wearer and those around them.

### RELATED APPLICATIONS

This application is a continuation-in-part of pending U.S. Application No. 18,387,441, filed Nov. 6, 2023, entitled “Smart Wearable Electric Devices and Methods for Communication,” which is a continuation of U.S. application Ser. No. 17/333,064, filed May 28, 2021, entitled “Smart Wearable Electric Devices and Methods for Communication,” the entirety of which are incorporated herein by reference.

### FIELD OF THE DISCLOSURE

The present disclosure relates to a hands-free, wireless, wearable, in-ear smart-phone device and charging station. More specifically, the smart-phone device is a small, portable communication device offering all the functionalities and capabilities of a mobile phone, audio, and music devices, and can be controlled through voice commands and embedded with software for a number of functionalities. The smart-phone device can be chargeable through an AC port or through solar charging technology. The smart-phone device falls under the broad category of smartphones and a complete functioning smart communication device housed within a ear-worn design. The smart-phone device contemplated herein can be categorized as wireless smart tech gadgets and devices.

Aspects of the smart-phone device relate more particularly to the integration of multiple functionalities within a small device. The smart-phone device supports all audio, video, and communication capabilities, while maintaining the functionality of a conventional smart phone. In short, the smart-phone device is in the shape of a wireless earphone, and can incorporate “Emotional Mirror” technology by working on sensors and voice-based command. The smart-phone device is an advancement to smart phone and audio technology, aligning with the demands of a fast-paced, healthy, and connected lifestyle.

### BACKGROUND

The term ‘smart-phone’ or ‘smart-phone device’ refers to a multi-functional mobile phone handset can comprise a camera and web browser and a high-density display. Other key features of a smart-phone can include storage space, micro SD card slots to allow a user to upgrade software, and intuitive touchscreen user interfaces to access the functions of the smart-phone quickly and easily. The benefits originally began with transistors and Walkman have since extended to devices such as cell phones, PDAs, televisions, MP3 players, and tablet computers, which are no longer limited to internet connectivity, but are enhanced with software that enables these devices to function as versatile multimedia platforms.

Conventional smart-phones come in a phone shape irrespective of the size. Consumers use wireless earphones or Bluetooth to operate them without picking them up by hand and place wireless earphones or Bluetooth devices into the user's ear canal. Users of earphones and Bluetooth devices plug the headset into the device to privately listen to the audio output from the device without disturbing others around the user. Conventional headsets have one or two earphones and may include a microphone for applications where user audio input is needed, for example, for use with a telephone. A user can often wear the headset whether listening to an audio signal or not. The traditional smart-phone and mobile communication sets were usually large and were not wireless, along with not having the facility of internet connectivity and work on voice command.

Multiple types of advancements have been seen in mobile devices and their utilities. For example, U.S. Patent Publication No. 2003/0087677A1 entitled “Self-powered wireless communication device and method of use” relates to a power generating mechanism with a movable element mounted to a wireless communication device. The movement of the movable component generates electricity via the power generating mechanism to allow a user to make a phone call when a battery of the device is discharged. The power generating mechanism can be a mechanical type or a piezoelectric type and involve a keypad, a battery cover, an antenna, a crank, or a keypad cover. The wireless device can also include an auxiliary power source and a switch to activate the auxiliary power source when needed, and a light adapted to illuminate when a call is received.

U.S. Pat. No. 7,289,831B2 entitled “Endless powered anywhere cellphone system” is directed to a cellphone system, cellphone flip or non-flip types (10) removable or collapsible hand crank to dynamo (12) external dynamo attachment (14) external solar cell attachment (16) dynamo and solar cell attachment jack (18) solar cells (20) cellphone charging dock (22).

U.S. Patent Publication No. 2008/0024011A1 entitled “Charger for cellular phone” provides a charger for the cellular phone comprising a body having a well and a battery compartment on its opposite surfaces, at least one pair of positive and negative terminals in the battery compartment, at least one pair of electrical contacts on the well and a charging circuit inside the body being electrically coupled to and the electrical connections and terminals respectively. When the cellular phone is rested on the well, the charging plugs of the cellular phone are electrically connected to the electrical contacts. Thus, the charging circuit is adapted to automatically supply power from either the external power source or the cells (or batteries) received in the battery compartment to charge at least one electrical energy storage element in the cellular phone.

U.S. Patent Publication No. 2006/0108976A1, entitled “non-contact charging device” discloses a non-contact charging device that includes a charging seat and a receiving end. The device is characterized by the charging center being disposed of with an active coil and a power circuit. The receiving end is provided with an inductive coil, a conversion circuit, and an electric cell at an interior thereof. Using the structures described above, electric power is transmitted from the charging seat to the receiving end using electromagnetic induction by approaching the active coil with the inductive coil. Without requiring a design of connecting terminals, terminal damages and poor contact is prevented from reducing production cost.

Multiple devices have been proposed regarding bringing advancement and enhanced utility regarding advances in selfie devices. Furthermore, the utilization of these systems in daily life is pretty cumbersome and non-effective. Also, the features of these utility systems are somewhat limited.

In contrast, it is an object of the present disclosure to create a smartphone with the latest miniaturizing trend, embedded with the latest software, having all the functionalities of a typical smart-phone in the size of a small wireless gadget with a look of a wireless earphone. In actuality, the smart-phone device is a complete communication device that can respond to everything from an individual's emotional state to their interactions with others with light, color, and opacity; these adaptive materials create a novel communication stream that informs both the wearer and those around them.

### SUMMARY

The following summary is provided to understand some of the innovative features unique to the present smart-phone device and is not intended to be a complete description. A full appreciation of the various aspects of the smart-phone device can be gained by taking the entire specification, claims, drawings, and abstract as a whole.

Considering the advances in technology, the primary objective of the smart-phone device relates to the latest trend of miniaturizing devices, embedded with the latest software, having all functionalities of a typical smart-phone in a small design with a look of a wireless earphone. The smart-phone device is a complete communication device that can respond to everything from an individual's emotional state to their interactions with others with light, color, and opacity; these adaptive materials create a novel communication stream that informs both the wearer and those around them.

The smart-phone device can recognize voice commands and analyze them, perform the task, and report back. The smart-phone device can also shut down when not in use and includes manually and voice-activated remote sensors, which can be used in place of a ‘wake word’.

The smart-phone device can be a miniature, hands-free, wireless, wearable, solar-powered, smart phone that is placed in a user's ear similar, to an ear bud. Despite having a unique shape and charging capacity with wireless and wearable features, the smart-phone device can perform all functions of a complete cell phone and a communication device, and can have all parts of an audio-video player. The smart-phone device can be connected to the World Wide Web (internet) and can perform live streaming for audio and video, the complete functionality of texting including reading, writing and sending messages and e-mails. The smart-phone device can operate via a speaker phone. As a smart gadget, smart-phone device can access the Internet, take voice commands, transfer/exchange/store cloud-based data, and be transferred to any other device through a USB port. It includes the functionalities of a camera and is GPS enabled. All possible skills for consumer convenience are embedded, giving the consumer an all-in-one capability wireless smart-phone, which can be worn as an earphone.

This summary is provided merely for summarizing some example embodiments to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWING

The accompanying figures, where like reference numerals refer to identical or functionally similar elements throughout the separate views, together with the detailed description below, are incorporated in and form part of the specification and serve to illustrate further embodiments of concepts that include the claimed invention and explain various principles and advantages of those embodiments.

FIG. 1 shows the upper view of one embodiment of the smart-phone device. It shows the earbud portion is to be worn in-ear. It also shows the estimated size of the phone in comparison to the earpiece. It offers its sleek round design with the earpiece embedded in it for two-way communication.

FIG. 2 shows the front view of the smart-phone device, the part that would be inserted in the ear and part that would emit sound. It offers the design and ear resting position of the device.

FIG. 3 shows the side-view of the smart-phone device having a screen display. It provides the visibility and idea of the screen size and visibility of different functions. The figure provides the perspective of a phone with the phone indications.

FIG. 4 shows the same side view with a different display. The display is indicating an incoming call to be answered via voice connectivity or manual touching. The screen and image give a clear idea of the smart-phone device, which is like an earphone in shape but a smart-phone with multiple features.

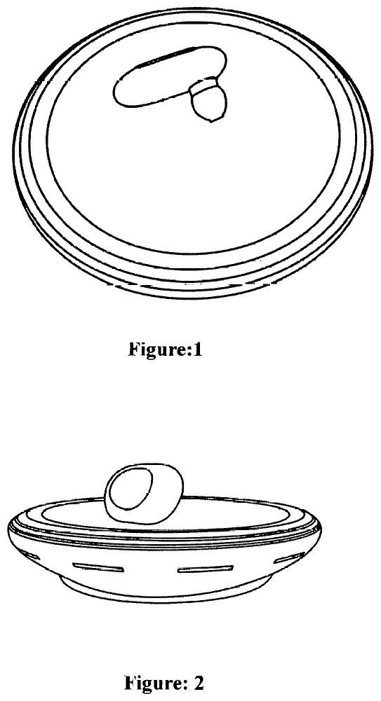

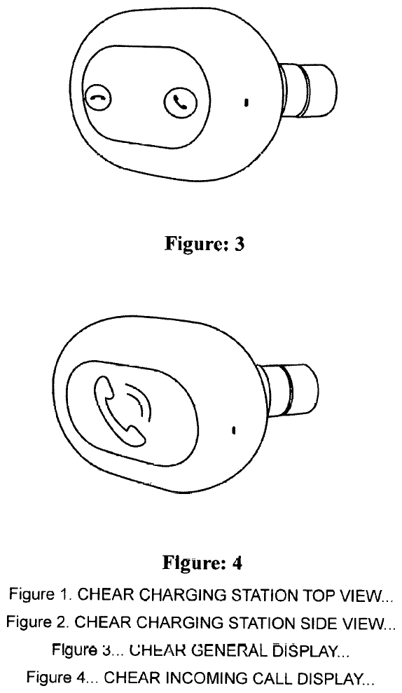

Skilled artisans will appreciate that elements in the figures are illustrated for simplicity and clarity and have not necessarily been drawn to scale. For example, the dimensions of some of the features in the figures may be exaggerated relative to other elements to help to improve understanding of embodiments of the smart-phone device.

The apparatus and method components have been represented where appropriate by conventional symbols in the drawings, showing only those specific details that are pertinent to understanding the embodiments of the smart-phone device so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present device may be embodied in various forms. Therefore, specific details disclosed herein are not to be interpreted as limiting but rather as a basis for the claims and as a representative basis for teaching one skilled in the art to employ the present device in virtually any appropriately detailed system, structure or manner.

In embodiments, the smart-phone device is wireless and does not require connectivity through wires. In embodiments, the smart-phone device can work as a Bluetooth device but is not Bluetooth. Internet connectivity of the smart-phone device makes it effective in handling. In certain embodiments, the smart-phone device will charge through an AC pin. In certain embodiments, the smart-phone device is rechargeable through solar light using natural resources. In such embodiments, the smart-phone device comprises solar cells with the capacity to charge from the sun or natural light other than its own solar docking and charging station. In embodiments, the smart-phone device lights up when it gets full charge as an indication.

In embodiments, the smart-phone device can connect to any device and is not limited to specific players. It is wireless, so it is wire-free. Through the connectivity, the smart-phone device can play music from multiple devices and different software platforms. In embodiments, the smart-phone device can connect to other smart phones, smart devices, and different operating systems to play music or audio by connecting to them. In embodiments, the smart-phone device can connect to a number of applications and music players other than computer and software-enabled devices. In embodiments, the smart-phone device can connect to the internet for live streaming, web browsing, e-mails, GPS, traffic maps and connection to remote devices.

In embodiments, the smart-phone device is GPS-enabled and can perform on automated voice directions in different turns and modes. The GPS feature will enable the smart-phone device to connect to live traffic, maps, satellites and servers for data streaming and downloading. In embodiments, the smart-phone device can recognize voice commands and analyze them, then perform the task and report back. In embodiments, the smart-phone device can also shut down when not in use. In embodiments, the smart-phone device has this unique feature of working on voice command through micro-controlled chip and software.

In embodiments, the smart-phone device has a camera for taking pictures and making videos. The smart-phone device, through its camera, has the audio-video communications ability for teleconferencing and video calls. In embodiments, the smart-phone device also supports all social media apps for full functionality.

In embodiments, the voice recognition capability of the smart-phone device is based on providing web services and enabled through a voice platform. As it is software-enabled, the functions of the smart-phone device is linked with the server through the World Wide Web. In embodiments, the smart-phone device will work if the signal strength of the internet is low, and gives good performance even at low latency, where factors like processing time, streaming, geo-disturbed service endpoints do not hinder the performance.

In embodiments, the smart-phone device can provide news and weather forecast from a variety of sources once it is connected to the internet. In embodiments, the smart-phone device can synchronize with radio stations to provide an update through internet connectivity. In the same context, the smart-phone device can play music directly from music accounts and have built-in support for streaming music services. In embodiments, the smart-phone device provides support to thermostats and can play music from streaming services like Apple and Google Play. In embodiments, the smart-phone device can synchronize through a phone or tablet for playing the music if required.

In embodiments, the smart-phone device supports activities like listening to audio books and other online audio devices through streaming. As the device operates through internet connectivity and connects through a server, the smart-phone device can maintain voice-controlled alarms, timers, shopping and to-do lists, and access online articles. In embodiments, the smart-phone device responds to questions about items by connecting to the internet and other related databases and devices.

In embodiments, the smart-phone device has the capability of real-time two-way and multi-feed wireless voice, data and audio-video streaming, telecommunications, and teleconferencing, coordinated applications, and shared functionality between one or more wirelessly networked mobile devices or other paired or networked wired or wireless devices and optimized device and data management over multiple wired and wireless network connections.

In embodiments, an extensive collection of self-service APIs, Apps, tools, documentation, and code samples is available to get the facilitation of self-services mentioned above. The software can be updated, and more features can be added to customize the functionalities. The same can be used through connectivity to the internet and other devices.

As the device is internet-connected and operates through server-based software, overtime period, new versions and software releases will fix bugs and include enhanced functionality. The smart-phone device will work on artificial intelligence and the device system can be updated through software and cloud networking, once connected to the internet.

In embodiments, the smart-phone device can comprise a hot spot and wireless router supporting direct connect multi-device ad-hoc virtual private networking (VPN). The smart-phone device can use operating systems, including, e.g., Fire OS. Besides this, Wi-Fi tethering enables the smart-phone device to connect to a Wi-Fi hotspot on a mobile device, including public Wi-Fi. In embodiments, the smart-phone device also features an option to plug into a wall charger or USB outlet. In embodiments, the smart-phone device includes 3D spatial perception.

In embodiment, the smart-phone device operates via voice command and voice vibration. The smart-phone device can allow a user to talk back with an “ear microphone” that transmits the user's voice by picking up the vibrations in the user's ear canal. In embodiments, the smart-phone device has built-in intelligence to choose among available network protocols while supporting various onboard and remote operational controls. The smart-phone device does not need to sync with another instrument, headset, or handset of any kind.

In embodiments, the smart-phone includes a solar-powered docking and charging station. In embodiments, the station comprises a color-changing LED light system embedded along the top edge, which emits a circumvolving light pattern during the charging process. Once the device reaches full charge, the LED device can transition into a low-power sleep mode. In embodiments, the station comprises solar panels on one or more top or side surfaces to maximize energy capture. A cyclonic energy conversion system generates, converts, and transfers power in order to maintain continuous energy supply until the device is fully charged.

In embodiments, the smart-phone device allows phone calls wirelessly and is a wireless smart phone (not Bluetooth connected). In embodiments, the smart-phone device comprises a solar panel mounted on the top surface of the housing. In embodiments, power is drawn from natural light through the solar panel in order to recharge its internal battery. In embodiments, in addition to, or in place of, the ability to utilize solar power, the smart-phone device, as any standard smart phone, also has the feature to recharge through an AC outlet.

In embodiments, the smart-phone device can comprise one or more biometric and environmental sensors to collect and analyze physiological and contextual data to detect and infer an individual's emotional and physical state. In embodiments, the smart-phone device can dynamically adjust its functionality and appearance to create a novel communication stream that provides feedback to the wearer and other individuals.

In embodiments, the one or more biometric sensors of the smart-phone device configured to monitor the user's physical and emotional condition can comprise, e.g., a pulse oximeter, heart rate monitor, thermometer, and motion sensor generally using gyroscope and accelerometer devices. These sensors are configured to monitor various biometric indicators, including heart rate variability, oxygen saturation, skin temperature, and physical movement or activity level. Using these inputs, in embodiments, the smart-phone device can infer an individual's emotional state (e.g., stress, anxiety, calmness, excitement, sadness, fatigue, attentiveness) and respond. For example, an elevated heart rate may be interpreted as sign of stress, variations in skin temperature may indicate anxiety or excitement, and specific patterns of physical movement can correspond to restlessness or fatigue. In embodiments, in response to the individual's emotional state, the smart-phone device can alter its external appearance (e.g., through color change or pulse patterns of light-emitting diodes (LEDs)) to communicate emotional cues to surrounding individuals, provide personalized audio feedback (e.g., by playing calming music when stressed, or energetic music when fatigued), and directly communicate the individual's emotional state to a second person via a communication network (e.g., a text message, email, voice message).

In embodiments, the smart-phone device can further comprise one or more environmental sensors configured to detect external environmental information of the individual. In embodiments, the one or more environmental sensors can include, e.g., a microphone for detecting ambient noise levels, light sensors for measuring light intensity, thermometers for detecting environmental temperature, barometers for detecting atmospheric or other pressure, and air quality sensors. In embodiments, in response to environmental data collected via the one or more environmental sensors, the smart-phone device can be configured to perform one or more adaptive actions, including, e.g., fade music or active audio upon detection of a sudden loud noise, adjust its external lighting in response to low ambient light conditions, initiate an alert when exposed to high temperatures or poor air quality, and activate noise-cancelling in a loud environment.

In embodiments, the smart-phone device can further comprise a holographic display system configured to project visual content in a manner that overcomes spatial limitations of the small design of the device. In embodiments, the holographic display comprises one or more retractable or foldable linear display arms configured to be stored within the housing of the device when not in use. In embodiments, the one or more linear display arms comprises an array of light-emitting elements (e.g., LEDs) disposed along the length of the arm. In operation, the one or more linear arms are swept rapidly along a defined trajectory of a two-dimensional area of space at a frequency exceeding the visual fusion threshold of the human eye to produce a “persistence of vision” effect. The timely energization of each of the plurality of LEDs in coordination with rapid mechanical movement of the one or more linear display arms creates a cohesive, visually persistent image for the illusion of a floating holographic object. The holographic display system can be configured to project various types of visual content, e.g., alphanumeric characters, graphical icons, user interface elements, notifications, and other information.

The design of the smart-phone device protects the small device from all shocks and damages. In embodiments, the smart-phone device has a combined blend of plastic and rubber that will produce a protective shell that will absorb shock and protect the screen.

In embodiments, the smart-phone device provides a safety factor being hands-free as a convenience factor for all incoming and outgoing calls. The same includes facilitation during driving like a Bluetooth set.

The smart-phone device is an ergonomic, compact, and lightweight design, which does not require any unwanted bulk in driving space. The smart-phone device provides an efficient, stylish, wireless smart-phone, which can be charged on the way through the car charger or simply by plugging it into any port in your car.

The smart-phone device provides a struggle free and minimizes accident risks against the inconvenience of big clumsy phones or wires while driving. The smart-phone device will bring a revolutionary new versatile smart-phone with premium-quality sound, ultra-powerful charging and long-lasting battery in a miniaturized phone set.

The ultra-lightweight and compact design means less clutter in a user's driving area. The flexible, bendable, earpiece ensures a comfortable and safe fit. The smart-phone device will ensure that no call is missed while being on the road and do it with state of the art noise and echo cancellation technology. The smart-phone device is an ultra-secure, secure fit which would suit men and women of all age groups and different demographics.

The Abstract of the Disclosure is provided to allow the reader to ascertain the nature of the technical disclosure quickly. It is submitted to understand that it will not be used to interpret or limit the scope or meaning of the claims. In addition, in the preceding Detailed Description, it can be seen that various features are grouped in various embodiments to streamline the disclosure. This method of disclosure is not to be interpreted as reflecting an intention that the claimed embodiments require more features than are expressly recited in each claim. Instead, as the following claims reflect, the inventive subject matter lies in less than all features of a single disclosed embodiment. Thus the following claims are hereby incorporated into the Detailed Description, with each claim standing on its own as a separately claimed subject matter.

What is claimed is:

1. A wireless smartphone device comprising:
a housing portion; the housing portion comprising:
one or more cameras;
one or more microphones configured to receive and transmit an audio signal;
one or more biometric sensors;
one or more environmental sensors;
a holographic display system; and
a display; and
an earbud portion disposed on and extending from a surface of the housing portion, the earbud portion configured for insertion into the ear canal of a user.

2. The wireless smartphone device of claim 1, wherein the one or more biometric sensors comprises at least one of a pulse oximeter, heart rate monitor, thermometer, and motion sensor.

3. The wireless smartphone device of claim 2, wherein the wireless smartphone device is configured to analyze data collected from the one or more biometric sensors and determine a user's emotional state.

4. The wireless smartphone device of claim 3, wherein the wireless smartphone device communicates the user's emotional state to a second user through a communication network.

5. The wireless smartphone device of claim 1, wherein the one or more environmental sensors comprises at least one of a microphone, light sensor, thermometer, and air quality sensor.
